(19) United States
(12) Patent Application Publication
(10) Pub. No.: US 2024/0118106 A1
(43) Pub. Date: Apr. 11, 2024

(54) MODULE INSPECTION METHOD AND INERTIAL SENSOR

(71) Applicant: Panasonic Intellectual Property Management Co., Ltd., Osaka (JP)

(72) Inventor: Yoichi NAKAYOSHI, Fukui (JP)

(21) Appl. No.: 18/548,309

(22) PCT Filed: Mar. 4, 2022
(86) PCT No.: PCT/JP2022/009383

§ 371 Date: Aug. 29, 2023

(30) Foreign Application Priority Data
Mar. 10, 2021 (JP) 2021-038785

(51) Int. Cl. G01C 25/00; G01P 21/00

(52) U.S. Cl. CPC G01C 25/005; G01P 21/00

(57) ABSTRACT

A module inspection method is a method for inspecting a module in which an inertial sensor is incorporated, and the module inspection method includes: acquiring sensor sensitivity information corresponding to a predetermined inertial force of the inertial sensor; applying a module electric test signal to the inertial sensor incorporated in a module to obtain module sensitivity information corresponding to the predetermined inertial force; making a comparison between the module sensitivity information and the sensor sensitivity information; and inspecting the module with reference to a result of the comparison between the module sensitivity information and the sensor sensitivity information.

### TECHNICAL FIELD

The present disclosure generally relates to module inspection methods and inertial sensors and specifically relates to a method for inspecting a module including an inertial sensor incorporated therein and the inertial sensor for the module inspection method.

### BACKGROUND ART

A known example of a method for inspecting the sensitivity of a module including an inertial sensor incorporated therein is an inspection method using an inertial force and an inspection method using a electric test signal. In the inspection method using the inertial force, an inspection device causes an inertial force to act on a module and inspects sensitivity information obtained from the module. On the other hand, in the inspection method using the electric test signal, a self-diagnosis function of an inertial sensor as disclosed in Patent Literature 1 is used to obtain sensitivity information.

### CITATION LIST

### Patent Literature

Patent Literature 1: JP 2010-175393 A

### SUMMARY OF INVENTION

It is an object of the present disclosure to provide a module inspection method and an inertial sensor configured to highly accurately conduct an inspection without using an inertial force.

A module inspection method according to one aspect of the present disclosure is a method for inspecting a module in which an inertial sensor is incorporated. The module inspection method includes acquiring sensor sensitivity information corresponding to a predetermined inertial force of the inertial sensor. The module inspection method includes applying a module electric test signal to the inertial sensor incorporated in the module to obtain module sensitivity information corresponding to the predetermined inertial force. The module inspection method includes making a comparison between the module sensitivity information and the sensor sensitivity information. The module inspection method includes inspecting the module with reference to a result of the comparison between the module sensitivity information and the sensor sensitivity information.

An inertial sensor according to an aspect of the present disclosure is an inertial sensor for the module inspection method according to the one aspect of the present disclosure and includes a storage configured to store the sensor sensitivity information.

### BRIEF DESCRIPTION OF DRAWINGS

FIG. 1 is a schematic exterior view of a module according to an embodiment;

FIG. 2 is a schematic view of a sensor inspection device to which an inertial sensor according to the embodiment is attached;

FIG. 3A is a logical block diagram of the inertial sensor according to the embodiment;

FIG. 3B is a schematic diagram of a MEMS portion according to the embodiment;

FIG. 4 is a time chart of a relationship between a sensor electric test signal and a sensor response according to the embodiment;

FIG. 5A is a schematic diagram of the MEMS portion when a sensor test signal is not output to the inertial sensor;

FIG. 5B is a schematic diagram of a state of the MEMS portion when a sensor test signal corresponding to an inertial force in the positive direction of an x axis is output to the inertial sensor;

FIG. 5C is a schematic diagram of a state of the MEMS portion when a sensor test signal corresponding to an inertial force in the negative direction of the x axis is output to the inertial sensor;

FIG. 6 is a flowchart of a method for inspecting the inertial sensor according to the embodiment; and

FIG. 7 is a flowchart of a method for inspecting the module according to the embodiment.

### DESCRIPTION OF EMBODIMENTS

### Embodiment

An inspection method of a module 10 according to the present disclosure will be described below with reference to the drawings.

<Configuration>

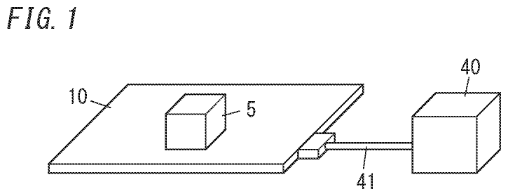

1. Overview of Module FIG. 1 is a schematic exterior view of the module 10 according to an embodiment. The module 10 to which the inspection method according to the embodiment is directed is, for example, a circuit board including an inertial sensor 5. More specifically, the module 10 according to the embodiment is an in-vehicle sensor substrate for automobiles, a gyroscope sensor substrate of a portable information terminal, a shake detection sensor substrate for cameras, a sensor substrate of an industrial robot, or a sensor substrate of a tractor. The module 10 is, for example, a circuit board having an outer dimension of about 10 cm square to about 20 cm square and having a predetermined shape. Note that the module 10 is not limited to the sensor substrates described above but may have an arbitrary configuration as long as it is a module which is a component of a device or a product and which includes the inertial sensor 5.

2. Overview of Module Inspection Device and Sensor Inspection Device

FIG. 1 shows the module 10 connected to a module inspection device 40. The module inspection device 40 includes an interface 41 for communication with the module 10. The module inspection device 40 outputs a module electric test signal described later to the module 10 and acquires a sensor response described later, thereby generating module sensitivity information. Specific description will be given later. The module inspection device 40 is embodied by a combination of, for example, a computer and software. More specifically, the module inspection device 40 includes a computer system. The computer system includes a processor and memory as principal hardware components thereof. The processor executes a program stored in the memory of the computer system to implement a function as the module inspection device 40 in the present disclosure. The program may be stored in advance in the memory of the computer system. Alternatively, the program may also be provided over a telecommunications network or be distributed after having been recorded in some non-transitory storage medium such as a memory card, an optical disc, or a hard disk drive, any of which is readable for the computer system. The processor of the computer system includes one or more electronic circuits including a semiconductor integrated circuit (IC) or a large scale integrated circuit (LSI).

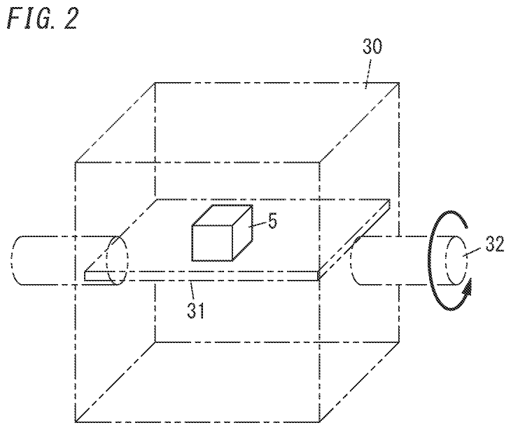

FIG. 2 is a schematic diagram of the inertial sensor 5 attached to a sensor inspection device 30. The sensor inspection device 30 is an inspection device for inspecting the inertial sensor 5. The sensor inspection device 30 includes a sensor platform 31 which holds the inertial sensor 5. The sensor platform 31 has an interface for communication between the inertial sensor 5 and the sensor inspection device 30. Moreover, the sensor platform 31 fixes the inertial sensor 5 such that the position of the inertial sensor 5 and the position of the sensor platform 31 move in conjunction with each other. Thus, when a moving portion 32 changes the position of the sensor platform 31, the position of the inertial sensor 5 is also changed in conjunction with the sensor platform 31. That is, the sensor platform 31 controls an inertial force which is to act on the inertial sensor 5. The sensor inspection device 30 controls the position of the sensor platform 31 to cause the inertial force to act on the inertial sensor 5 and acquires the sensor response described later, thereby inspecting the inertial sensor 5. Moreover, the sensor inspection device 30 outputs a sensor electric test signal described later to the inertial sensor 5 and acquires a sensor response described later, thereby generating sensor sensitivity information. Specific description will be given later.

3. Configuration of Inertial Sensor

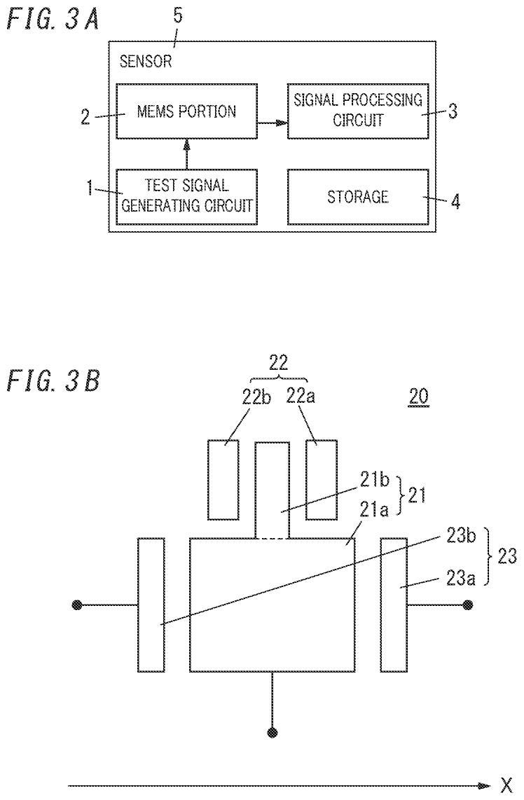

FIG. 3A is a block diagram of a logical configuration of the inertial sensor 5 according to the embodiment. The inertial sensor 5 according to the embodiment is an inertial sensor for a module inspection method according to the embodiment. The inertial sensor for the module inspection method means the inertial sensor 5 incorporated in the module 10 to be inspected by the module inspection method.

The inertial sensor 5 includes a test signal generating circuit 1, a MEMS portion 2, a signal processing circuit 3, and a storage 4.

The test signal generating circuit 1 is a circuit configured to apply a voltage to the MEMS portion 2. The test signal generating circuit 1 receives an input of the sensor electric test signal from the sensor inspection device 30 to which the inertial sensor 5 is attached. The test signal generating circuit 1 applies a voltage to the MEMS portion 2 in accordance with the sensor electric test signal. Moreover, the test signal generating circuit 1 receives an input of the module electric test signal from the module inspection device 40 connected to the module 10. The test signal generating circuit 1 applies a voltage to the MEMS portion 2 in accordance with the module electric test signal.

The MEMS portion 2 is an inertia detecting portion as a so-called Micro Electro Mechanical Systems (MEMS). The MEMS portion 2 is a six-axis gyroscope sensor (six-axis inertial sensor) including, for example, a three-axis angular velocity sensor and a three-axis acceleration sensor. The MEMS portion 2 includes three acceleration sensors 20 and three angular velocity sensors (not shown). FIG. 3B is a schematic diagram of an overview of one of the acceleration sensors 20 included in the MEMS portion 2. The acceleration sensor 20 shown in FIG. 3B is an inertia detecting portion configured to detect an x-axis component of acceleration. Each acceleration sensor 20 includes a weight 21, a detection electrode portion 22, and a test signal electrode portion 23. Note that an acceleration sensor 20 configured to detect a y-axis component and an acceleration sensor 20 configured to detect a z-axis component also include similar components to those of the acceleration sensor 20 configured to detect the x-axis component.

The weight 21 includes a main part 21a and an electrode part 21b. The main part 21a is disposed between two test signal electrodes 23a and 23b (described later) of the test signal electrode portion 23. More specifically, the main part 21a is disposed between the two test signal electrodes 23a and 23b in an x-axis direction. The electrode part 21b is disposed between two detection electrodes 22a and 22b of the detection electrode portion 22. Specifically, the electrode part 21b is disposed between the two detection electrodes 22a and 22b in the x-axis direction. Examples of a material for the weight 21 include silicon. Although not shown, the weight 21 is held by, for example, an elastic body. The weight 21 remains still at a predetermined reference position when no inertial force including the x-axis component acts thereon. When an inertial force in the positive direction of the x axis acts on the weight 21, the weight 21 moves in the positive direction of the x axis. Moreover, when an inertial force in the negative direction of the x axis acts on the weight 21, the weight 21 moves in the negative direction of the x axis. The position of the weight 21 after moved along the x axis corresponds to the magnitude of the inertial force. More specifically, the greater the inertial force acting on the weight 21, the farther the weight 21 moves away from the predetermined reference position.

The detection electrode portion 22 is an electrode configured to detect the position of the weight 21 with reference to a change in electrostatic capacitance. The detection electrode portion 22 includes the detection electrode 22a and the detection electrode 22b. The detection electrodes 22a and 22b are fixed to a substrate such that the electrode part 21b of the weight 21 is located therebetween. The detection electrode 22a and the detection electrode 22b are connected to the signal processing circuit 3. More specifically, the signal processing circuit 3 applies a voltage to the weight 21 and the detection electrodes 22a and 22b such that each of a potential difference between the weight 21 and the detection electrode 22a and a potential difference between the weight 21 and the detection electrode 22b is a predetermined value. When the weight 21 moves in the x-axis direction, a distance between the electrode part 21b and the detection electrode 22a changes. This changes the electrostatic capacitance between the electrode part 21b and the detection electrode 22a. In similar fashion, when the weight 21 moves in the x-axis direction, the distance between the electrode part 21b and the detection electrode 22b changes. This changes the electrostatic capacitance between the electrode part 21b and the detection electrode 22b.

The test signal electrode portion 23 is an electrode configured to control the position of the weight 21 by using an electrostatic force. The test signal electrode portion 23 includes the test signal electrode 23a and the test signal electrode 23b. The test signal electrodes 23a and 23b are fixed to the substrate such that the main part 21a of the weight 21 is located therebetween. The test signal electrode 23a, the test signal electrode 23b, and the weight 21 are connected to the test signal generating circuit 1. When application of a voltage from the test signal generating circuit 1 produces a potential difference between the test signal electrode 23a and the weight 21, an electrostatic force in the x-axis direction acts on the weight 21. In similar fashion, when application of a voltage from the test signal generating circuit 1 produces a potential difference between the test signal electrode 23b and the weight 21, the electrostatic force in the x-axis direction acts on the weight 21. The test signal electrode portion 23 causes the electrostatic force to act on the weight 21, thereby creating a state similar to a state where an inertial force acts on the weight 21. That is, the test signal electrode portion 23 causes the electrostatic force to act on the weight 21, thereby moving the weight 21 in the x-axis direction.

Returning to FIG. 3A, description will be continued. The signal processing circuit 3 is a circuit configured to output a sensor response. More specifically, the signal processing circuit 3 detects displacement of the weight 21 by using the detection electrode portion 22 of the MEMS portion 2 and outputs the sensor response. As described above, the signal processing circuit 3 applies a voltage to the detection electrode 22a and the detection electrode 22b such that each of the potential difference between the weight 21 and the detection electrode 22a and the potential difference between the weight 21 and the detection electrode 22b is kept at the predetermined value. Then, a change in electric charge amount of each of the detection electrode 22a and the detection electrode 22b is detected with reference to the amount of a current flowing in, or flowing out, of each of the detection electrode 22a and the detection electrode 22b, respectively. Moreover, the signal processing circuit 3 calculates, from the change in the electric charge amount of each of the detection electrode 22a and the detection electrode 22b, the direction and the magnitude of the x component of the inertial force on the basis of the position of the weight 21 in the x-axis direction, and the signal processing circuit 3 outputs the direction and the magnitude as the sensor response. In the inspection, the signal processing circuit 3 calculates, from the change in the electric charge amount of each of the detection electrode 22a and the detection electrode 22b, the direction and the magnitude of the x component of the electrostatic force acting on the weight 21 on the basis of the position of the weight 21 in the x-axis direction, and the signal processing circuit 3 outputs the direction and the magnitude as the sensor response.

The storage 4 is memory for storing sensitivity information on the inertial sensor 5. The storage 4 is nonvolatile memory such as Programmable Read Only Memory (PROM).

The test signal generating circuit 1, the signal processing circuit 3, and the storage 4 are implemented, for example, as a single Application Specific Integrated Circuit (ASIC).

<Method for Inspecting Inertial Sensor by Using Sensor Electric Test Signal>

A method for inspecting the inertial sensor 5 by using the sensor electric test signal will be described in detail below.

The sensor electric test signal is a signal output from the sensor inspection device 30 to inspect the inertial sensor 5. The sensor electric test signal includes at least one sensor test signal. The sensor test signal corresponds to an inertial force having a specific direction and a specific magnitude as described later. For the sake of simplification of description, the sensor test signal will hereinafter be represented by a single voltage value V. When the voltage value V representing the sensor test signal is a positive value, the test signal generating circuit 1 applies a voltage to the MEMS portion 2 such that the potential difference between the test signal electrode 23a and the weight 21 equals to the voltage value V. More specifically, the test signal generating circuit 1 applies the voltage between the test signal electrode 23a and the weight 21 such that the potential difference between the test signal electrode 23a and the weight 21 equals to the voltage value V. Note that the test signal generating circuit 1 causes the potential difference between the weight 21 and the test signal electrode 23b to be 0. When the test signal generating circuit 1 applies the voltage to the MEMS portion 2, the weight 21 receives an electrostatic force in the positive direction of the x axis. Thus, a sensor test signal represented by a positive voltage value V corresponds to the inertial force which is in the positive direction of the x axis and which displaces the weight 21 to the same position as a position to which the weight 21 is moved by the electrostatic force. Moreover, when the voltage value V representing the sensor test signal is a negative value, the test signal generating circuit 1 applies a voltage to the MEMS portion 2 such that the potential difference between the test signal electrode 23b and the weight 21 equals to the voltage value V. More specifically, the test signal generating circuit 1 applies the voltage between the weight 21 and the test signal electrode 23b such that the potential difference between the weight 21 and the test signal electrode 23b equals to the voltage value V. Note that the test signal generating circuit 1 causes the potential difference between the test signal electrode 23a and the weight 21 to be 0. When the test signal generating circuit 1 applies the voltage to the MEMS portion 2, the weight 21 receives an electrostatic force in the negative direction of the x axis. Thus, a sensor test signal represented by a negative voltage value V corresponds to an inertial force in the negative direction of the x axis, and the inertial force in the negative direction of the x axis displaces the weight 21 to the same position as a position to which the weight 21 is moved by the electrostatic force. When the voltage value V representing the sensor test signal is 0, the test signal generating circuit 1 cases each of a voltage between the weight 21 and the test signal electrode 23a and a voltage between the weight 21 and the test signal electrode 23b to be 0. Thus, a sensor test signal represented by a voltage value V of 0 corresponds to an absence of the inertial force. That is, the sign of the voltage value V representing the sensor test signal corresponds to the direction of a corresponding inertial force. Note that as the voltage value V representing the sensor test signal, increases, the electrostatic force increases, and therefore the displacement of the weight 21 also increases. That is, the absolute value of the voltage value V representing the sensor test signal corresponds to the magnitude of a corresponding inertial force.

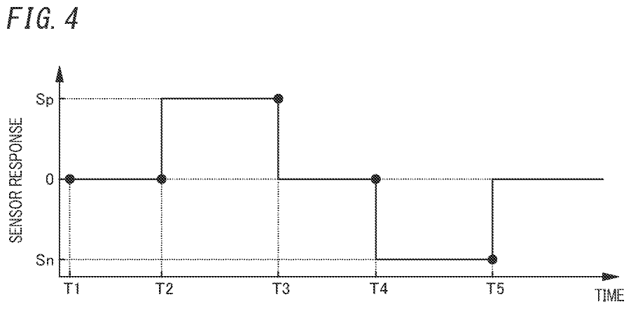

FIG. 4 is an example of a time chart of an overview of the sensor response to the sensor electric test signal. The sensor electric test signal shown in FIG. 4 includes three sensor test signals, namely the sensor test signal corresponding to the inertial force in the positive direction of the x axis, the sensor test signal corresponding to the inertial force in the negative direction of the x axis, and the sensor test signal corresponding to the absence of the inertial force. Note that the following description assumes that no inertial force acts on the inertial sensor 5.

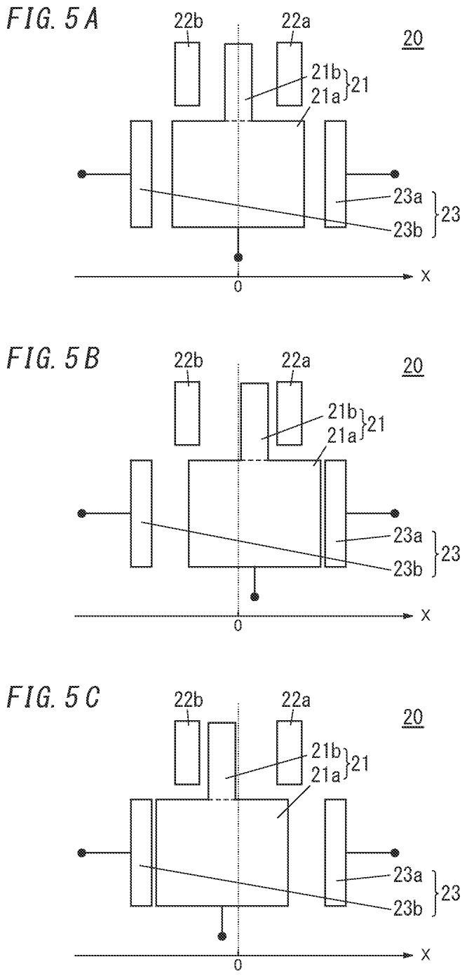

From a time T1 to a time T2, no sensor test signal is input to the inertial sensor 5. FIG. 5A is a schematic diagram of a state of the acceleration sensor 20 of the MEMS portion 2 when no sensor test signal is output to the inertial sensor 5. Since no force in the x-axis direction acts on the weight 21, the weight 21 is present at a position at which x=0 and which serves as a reference as shown in FIG. 5A. Thus, the electric charge amount of each of the detection electrode 22a and the detection electrode 22b is equal to that in a state where the weight 21 is at the position at which x=0 and which serves as the reference. That is, the inertial sensor 5 outputs, as the sensor response, a value 0 representing the absence of the inertial force.

Then, from the time T2 to a time T3, a sensor test signal which is included in the sensor electric test signal and which corresponds to a predetermined inertial force in the positive direction of the x axis is input to the inertial sensor 5. Since the voltage value representing the sensor test signal is positive, the test signal generating circuit 1 outputs a voltage to the MEMS portion 2 such that a potential difference is produced between the weight 21 and the test signal electrode 23a. FIG. 5B is a schematic diagram of the state of the acceleration sensor 20 of the MEMS portion 2 when the sensor test signal corresponding to the predetermined inertial force in the positive direction of the x axis is output to the inertial sensor 5. As described above, an electrostatic force pulling the weight 21 toward the test signal electrode 23a acts on the weight 21, and therefore, the weight 21 moves in the positive direction of the x axis as shown in FIG. 5B. Thus, the electric charge amount of each of the detection electrode 22a and the detection electrode 22b shows that the weight 21 is present at a position moved in the positive direction of the x axis from the position serving as the reference. That is, the inertial sensor 5 outputs, as the sensor response, a value Sp representing the inertial force in the positive direction of the x axis.

Next, from the time T3 to a time T4, the sensor test signal which is included in the sensor electric test signal and which corresponds to the absence of the inertial force is input to the inertial sensor 5. In this case, the potential difference between the weight 21 and the test signal electrode 23a is 0. Moreover, the potential difference between the weight 21 and the test signal electrode 23b is 0. Thus, no electrostatic force from the test signal electrode portion 23 acts on the weight 21. Therefore, as in the case where no sensor electric test signal is output to the inertial sensor 5, the weight 21 returns to the position at which x=0 and which serves as the reference as shown in FIG. 5A. That is, the inertial sensor 5 outputs, as the sensor response, a value 0 representing the absence of the inertial force.

Next, from the time T4 to a time T5, a sensor test signal which is included in the sensor electric test signal and which corresponds to a predetermined inertial force in the negative direction of the x axis is input to the inertial sensor 5. Since the voltage value representing the sensor test signal is negative, the test signal generating circuit 1 outputs a voltage to the MEMS portion 2 such that a potential difference is produced between the weight 21 and the test signal electrode 23b. FIG. 5C is a schematic diagram of the state of the acceleration sensor 20 of the MEMS portion 2 when the sensor test signal corresponding to the predetermined inertial force in the negative direction of the x axis is output to the inertial sensor 5. As described above, an electrostatic force pulling the weight 21 toward the test signal electrode 23b acts on the weight 21, and therefore, the weight 21 moves in the negative direction of the x axis. Thus, the electric charge amount of each of the detection electrode 22a and the detection electrode 22b shows that the weight 21 is present at a position moved in the negative direction of the x axis from the position serving as the reference. That is, the inertial sensor 5 outputs, as the sensor response, a value Sn representing the inertial force in the negative direction of the x axis.

Finally, at and after the time T5, no sensor test signal is input to the inertial sensor 5. In this case, no electrostatic force from the test signal electrode portion 23 acts on the weight 21. Thus, the weight 21 returns to the position at which x=0 and which serves as the reference as shown in FIG. 5A. That is, the inertial sensor 5 outputs, as the sensor response, a value 0 representing the absence of the inertial force.

As described above, in response to inputting, to the inertial sensor 5, the sensor electric test signal including the sensor test signals corresponding to the respective inertial forces, the sensor response can be obtained from the inertial sensor 5. Note that in the present disclosure, saying that a sensor response P obtained when an inertial force X is caused to act on the inertial sensor 5 and a sensor response Q obtained when a sensor test signal Y is input to the inertial sensor 5 are identical means that the sensor test signal Y corresponds to the inertial force X. A similar description applies to the relationship between the sensor electric test signal and the inertial force.

<Method for Inspecting Module by Using Module Electric Test Signal>

A method for inspecting the module 10 by using the module electric test signal will be described below.

The module electric test signal is a signal output from the module inspection device 40 to inspect the module 10. The module electric test signal includes at least one module test signal. The module test signal corresponds to an inertial force having a specific direction and a specific magnitude. As in the case of the sensor test signal, the module test signal will hereinafter be represented by a single voltage value V. The influence of the module test signal represented by the voltage value V over the inertial sensor 5 of the module 10 is identical to the influence of the sensor test signal represented by the voltage value V over the inertial sensor 5. That is, the sign of the voltage value V representing the module test signal corresponds to the direction of a corresponding inertial force. The absolute value of the voltage value V representing the module test signal corresponds to the magnitude of a corresponding inertial force.

Note that the module test signal identical to the sensor test signal exerts an identical influence over the inertial sensor 5. That is, the sensor response from the inertial sensor 5 to the sensor test signal represented by the voltage value V is equal to the sensor response from the module 10 to the module test signal represented by the voltage value V. In similar fashion, the module electric test signal identical to the sensor electric test signal exerts an identical influence over the inertial sensor 5. The sensor test signal and the module test signal are hereinafter collectively referred to as a “test signal” when they do not have to be particularly distinguished from each other. Moreover, in similar fashion, the sensor electric test signal and the module electric test signal are hereinafter collectively referred to as a “electric test signal” when they do not have to be particularly distinguished from each other.

<Method for Inspecting Module>

A method for inspecting the module 10 according to the embodiment will be described below.

1. Method for Inspecting Inertial Sensor

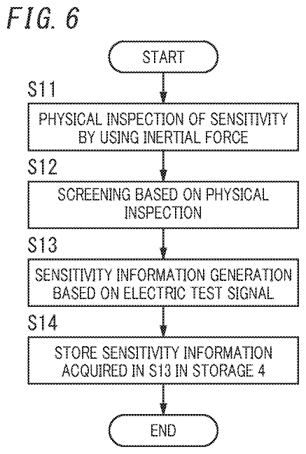

First of all, the method for inspecting, as a pre-process, the inertial sensor 5 will be described before the description of the method for inspecting the module 10. Note that the method for inspecting the inertial sensor 5 is performed before the inertial sensor 5 is incorporated into the module 10. FIG. 6 is a flowchart of the method for inspecting the inertial sensor 5.

First of all, the inertial sensor 5 is subjected to a physical inspection of sensitivity by using an inertial force (step S11). Specifically, the inertial sensor 5 is, first of all, attached to the sensor platform 31 of the sensor inspection device 30, thereby physically and electrically connecting the inertial sensor 5 to the sensor inspection device 30. Then, the sensor inspection device 30 causes an inertial force to act on the inertial sensor 5 by using the sensor platform 31. A method for causing the action of the inertial force is, for example, controlling the position of the inertial sensor 5 such that an inertial force detection direction of the inertial sensor 5 forms a predetermined angle with respect to the gravity direction, or rotating a platform on which the inertial sensor 5 has been installed at a constant speed by using a predetermined axis as a rotation axis. The sensor inspection device 30 acquires, as sensitivity information, a sensor response corresponding to the inertial force from the signal processing circuit 3 of the inertial sensor 5.

Next, the inertial sensor 5 is subjected to screening based on the physical inspection (step S12). Specifically, the sensor inspection device 30 calculates, with respect to the inertial force caused to act on the inertial sensor 5 in the step S11, an error in the inertial force represented by the sensitivity information thus acquired. Then, the sensor inspection device 30 determines an inertial sensor 5 for which the error is less than or equal to a predetermined permissible error to be non-defective, while the sensor inspection device 30 determines an inertial sensor 5 for which the error is greater than the predetermined permissible error to be defective. The predetermined permissible error is, for example, within the range of from −2% to +2% of the magnitude of the inertial force. The inertial sensor 5 determined to be defective is excluded from a target to be subsequently inspected.

Then, sensitivity information is generated based on a sensor electric test signal (step S13). Specifically, the sensor inspection device 30 outputs the sensor electric test signal to the inertial sensor 5 and acquires, as the sensitivity information, a sensor response to the sensor electric test signal from the signal processing circuit 3 of the inertial sensor 5. The sensor electric test signal may be, for example, the sensor electric test signal described above. Note that the sensor electric test signal is not limited to the examples described above but may be any signal including at least one sensor test signal corresponding to an inertial force.

Next, the sensitivity information is stored in the storage 4 of the inertial sensor 5 (step S14). Specifically, the sensor inspection device 30 stores, as the sensor sensitivity information, the sensitivity information acquired in the step S13 in the storage 4 of the inertial sensor 5.

Through the steps explained above, the inspection, which is the pre-process, of the inertial sensor 5 is completed.

2. Method for Inspecting Module

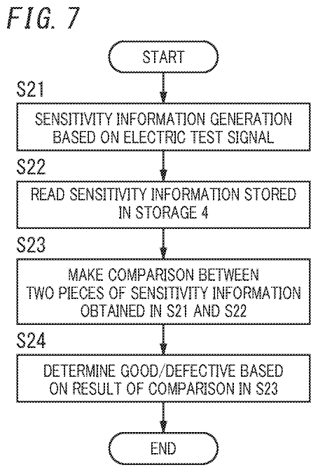

Next, the method for inspecting the module 10 will be described. Note that the method for inspecting the module 10 is performed after the inertial sensor 5 is incorporated into the module 10. FIG. 7 is a flowchart of the method for inspecting the module 10.

First of all, sensitivity information is generated based on the module electric test signal (step S21). Specifically, the module inspection device 40 is electrically connected to the module 10. Then, the module inspection device 40 outputs the module electric test signal to the module 10. The module inspection device 40 acquires, as module sensitivity information, a sensor response from the inertial sensor 5 to the module electric test signal from the signal processing circuit 3 of the inertial sensor 5. The module electric test signal output from the module inspection device 40 is a signal identical to the sensor electric test signal output from the sensor inspection device 30 in the step S13.

Then, the module inspection device 40 acquires the sensor sensitivity information from the storage 4 of the inertial sensor 5 incorporated in the module 10 (step S22).

Next, the module inspection device 40 makes a comparison between the module sensitivity information acquired in the step S21 and the sensor sensitivity information read in the step S22 (step S23).

Then, the module inspection device 40 determines, based on a result of the comparison in the step S23, whether the module 10 is non-defective or defective (step S24). For example, if an error in the module sensitivity information acquired in the step S21 with respect to the sensor sensitivity information stored in the storage 4 is within a predetermined range, the module inspection device 40 determines that the module 10 is non-defective. In contrast, if the error in the module sensitivity information is out of the predetermined range, the module inspection device 40 determines that the module 10 is defective. The predetermined range may be, for example, within the range of from −0.3% to +0.3% of the magnitude of the sensor sensitivity information. Note that the predetermined range may be narrower than the predetermined permissible error in the step S12.

Through these steps, the inspection of the module 10 is completed.

<Conclusion>

As described above, in the method for inspecting the module 10 according to the embodiment, the sensitivity information on the inertial sensor 5 to the sensor electric test signal is compared with the sensitivity information on the module 10 to the module electric test signal identical to the sensor electric test signal. Therefore, it can be indirectly confirmed that when the sensor sensitivity information on the inertial sensor 5 to the sensor electric test signal is equivalent to the module sensitivity information on the module 10 to the module electric test signal, equivalent sensitivity information is obtainable also to the inertial force. That is, the sensitivity information on the module 10 to the inertial force can be indirectly inspected without conducting the physical inspection of the sensitivity of the module 10 by using the inertial force.

Moreover, in the method for inspecting the module 10 according to the embodiment, the conducting of the physical inspection of the sensitivity of the module 10 by using the inertial force may be omitted. The module 10 is larger than the inertial sensor 5, and therefore, causing an inertial force to act on the module 10 requires a module inspection device 40 having a large moving portion for controlling the position and the like of the module 10. Moreover, the module inspection device 40 and the sensor inspection device 30 have to have equivalent accuracy in position control of the moving portion, and in addition, the module inspection device 40 has to take into consideration a relative relationship between the position of the module 10 and the position of the inertial sensor 5 in the module 10. However, the method for inspecting the module 10 according to the embodiment requires no moving portion for controlling the position and the like of the module 10 and does thus not have to take them into consideration.

Moreover, in the method for inspecting the module 10 according to the embodiment, the sensor sensitivity information on the sensor electric test signal is compared with the module sensitivity information on a module electric test signal identical to the sensor test signal. Thus, the method for inspecting the module 10 according to the embodiment enables the module 10 to be highly accurately inspected when the sensor electric test signal for acquiring the sensor sensitivity information and the module electric test signal for acquiring the module sensitivity information are identical. That is, the method for inspecting the module 10 according to the embodiment requires no highly accurate association of the module electric test signal to the inertial force.

Moreover, in the method for inspecting the module 10 according to the embodiment, the sensitivity information on the inertial sensor 5 to the sensor electric test signal is stored in the storage 4. That is, the module 10 includes a storage medium storing the sensor sensitivity information. Thus, the inspection of the module 10 and the inspection of the inertial sensor 5 may be temporally isolated. Moreover, the inspection of the module 10 and the inspection of the inertial sensor 5 may be spatially isolated. That is, also when manufacture and/or an inspection of the inertial sensor 5 and manufacture and/or an inspection of the module 10 are performed at different manufacturing bases and/or by different business operators, the inspection of the module 10 according to the embodiment can be easily conducted.

(First Variation)

In the embodiment, the sensor responses to the electric test signal are used as they are as the sensor sensitivity information and the module sensitivity information. However, the sensitivity information is not limited to the embodiment described above, but other information may be used.

In a first variation, the electric test signal includes at least two different test signals. That is, the sensor electric test signal includes a first sensor test signal and a second sensor test signal. The module electric test signal includes a first module test signal and a second module test signal. Moreover, each of the sensor inspection device 30 and the module inspection device 40 acquires sensor responses to the respective test signals. Then, each of the sensor inspection device 30 and the module inspection device 40 uses, as the sensitivity information, a difference between a sensor response to one test signal as a reference and a sensor response to the other test signal. Note that the other steps are the same as those in the embodiment, and the description thereof will thus be omitted.

The sensor electric test signal used in the first variation includes, for example, a first sensor test signal represented by a voltage value V1 and the second sensor test signal represented by a voltage value V2. Moreover, a sensor response from the inertial sensor 5 or the module 10 to the first sensor test signal represented by the voltage value V1 is defined as a first sensor response S1. In the first sensor response S1, a component corresponding to the first sensor test signal is defined as a component S1v, and a component which is not attributed to the sensor electric test signal is defined as a component St. In this case, the following equation holds true.

S1=S1v+St

Moreover, a sensor response from the inertial sensor 5 or the module 10 to the second sensor test signal represented by the voltage value V2 is defined as a second sensor response S2. Moreover, in the second sensor response S2, a component corresponding to the second sensor test signal is defined as a component S2v. In this case, the following equation holds true.

S2=S2v+St

Here, a difference ΔS between the first sensor response S1 and the second sensor response S2 is defined as the sensitivity information, and in this case, the following equation holds true.

ΔS=S2−S1=S2v−S1v

In similar fashion, the module electric test signal includes the first module test signal represented by the voltage value V1 and the module test signal represented by the voltage value V2. Moreover, a sensor response from the module 10 to the first module test signal is defined as a first sensor response S3. In the first sensor response S3, a component corresponding to the first module test signal is defined as a component S3v. Moreover, a sensor response from the module 10 to the second module test signal is defined as a second sensor response S4. In the second sensor response S4, a component corresponding to the second module test signal is defined as a component S4v. Here, a difference ΔS between the first sensor response S3 and the second sensor response S4 is defined as the sensitivity information, and in this case, in similar fashion, the following equation holds true.

ΔS=S4−S3=S4v−S3v

In the first variation, the method for inspecting the inertial sensor is different from that in the embodiment in the following point. To generate the sensor sensitivity information in the step S13, the sensor inspection device 30 outputs, as the sensor electric test signal, a sensor test signal including the first sensor test signal and the second sensor test signal to the inertial sensor 5. Then, the sensor inspection device 30 acquires the first sensor response from the inertial sensor 5 to the first sensor test signal. The sensor inspection device 30 further acquires the second sensor response from the inertial sensor 5 to the second sensor test signal. The sensor inspection device 30 then calculates, as the sensor sensitivity information, a difference between the first sensor response and the second sensor response. In the step S14, the sensor sensitivity information is then stored in the storage 4.

Moreover, in the first variation, the method for inspecting the module 10 is different from that in the embodiment in the following point. To generate the module sensitivity information in the step S21, the module inspection device 40 outputs, as the module electric test signal, a module test signal including the first module test signal and the second module test signal to the module 10. The voltage value of the first module test signal is equal to the voltage value of the first sensor test signal. The voltage value of the second module test signal is also equal to the voltage value of the second sensor test signal. Then, the module inspection device 40 acquires, from the module 10, the first sensor response to the first module test signal. The module inspection device 40 further acquires, from the module 10, the second sensor response to the second module test signal. The module inspection device 40 then calculates, as the module sensitivity information, a difference between the first sensor response and the second sensor response. In the step S23, the module inspection device 40 then makes a comparison between the module sensitivity information thus calculated in the step S21 and the sensor sensitivity information read from the module 10 in the step S22.

As described above, the sensor response which the inertial sensor 5 outputs in response to the sensor test signal includes the component St, which is not attributed to the sensor electric test signal. Moreover, the sensor response which the module 10 outputs in response to the module test signal includes a component St which is not attributed to the module electric test signal. Examples of the component St, which is not attributed to the electric test signal include a component which is attributed to an inertial force which physically acts on the inertial sensor 5, a component which is attributed to the circuit configuration of the module 10, and a component which is attributed to a circuit of the sensor inspection device 30 or the module inspection device 40. On the other hand, when the difference between the sensor responses from the inertial sensor 5 or the module 10 to two different test signals is used as the sensor sensitivity information or the module sensitivity information, neither the sensor sensitivity information nor the module sensitivity information includes the component St, which is not attributed to the electric test signal. Thus, the sensor sensitivity information which is the sensitivity information on the inertial sensor 5 and which is attributed to the sensor electric test signal can be compared with the module sensitivity information which is the sensitivity information on the module 10 and which is attributed to the module electric test signal, and thereby conducting a highly accurate inspection. That is, causes of generation of the component St, which is not attributed to the electric test signal, are a difference between inertial forces which are attributed to positional differences and/or the influence of a circuit except for the inertial sensor 5 in the module 10, and a reduction in inspection accuracy due to these causes can be reduced.

Note that a combination of the first test signal and the second test signal may be an arbitrary combination as long as their voltage values are different. When a range within which the single voltage values V representing the test signals can be set is from −5 V to +5 V, for example, any of the following combinations may be used. That is, the combination may be (+5 V, −5 V), or (+5 V, 0 V) or (0 V, −5 V) where one of the first test signal and the second test signal is defined as no signal. Moreover, the voltage values may have a single reference sign, that is, the combination may be (+5 V, +3 V) or (−5 V, −3 V). Note that the combinations explained above are mere examples, and an arbitrary combination may be used. Note that the extent of removal of the component St, which is not attributed to the electric test signal, depends on neither the difference between the signs of two voltage values nor the magnitude of the absolute value of the difference between the two voltage values. However, as the absolute value of the difference between the voltage values of the test signals increases, the absolute value of the difference between the sensor responses increases, and thereby, the signal-to-noise ratio of each of the sensor sensitivity information and the module sensitivity information is improved. Note that the electric test signal may further include a third test signal, and a difference between a sensor response to the third test signal and the sensor response to the first test signal may be further used as the sensitivity information.

(Second Variation)

In the embodiment, the sensor sensitivity information on the inertial sensor 5 and the module sensitivity information on the module 10 are acquired in a single environment. However, the sensor sensitivity information on the inertial sensor 5 and the module sensitivity information on the module 10 may vary depending on environmental temperatures, and therefore, an inspection of the sensitivity information may be conducted for each environmental temperature.

In a second variation, the sensor inspection device 30 acquires pieces of sensor sensitivity information in respective different temperature environments and stores the pieces of sensor sensitivity information for the respective temperature environments in the storage 4. Moreover, the module inspection device 40 acquires pieces of module sensitivity information for the respective different temperature environments. Then, the module inspection device 40 makes a comparison between the sensor sensitivity information and the module sensitivity information for each environmental temperature, thereby determining whether the module 10 is non-defective or defective. Note that the other steps are the same as those in the embodiment, and the description thereof will thus be omitted.

In the second variation, the method for inspecting the inertial sensor 5 is different from that in the embodiment in the following point. That is, the sensor inspection device 30 according to the second variation has a function of changing a temperature of the inertial sensor 5 and the sensor platform 31 to a first temperature and maintaining the first temperature. Moreover, the sensor inspection device 30 according to the second variation has a function of changing the temperature of the inertial sensor 5 and the sensor platform 31 to a second temperature and maintaining the second temperature. Then, to acquire the sensor sensitivity information in the step S13, the sensor inspection device 30 performs temperature management such that the temperature of the inertial sensor 5 is the first temperature. Then, in a state where the temperature of the inertial sensor 5 is the first temperature, the sensor inspection device 30 outputs the sensor electric test signal to the inertial sensor 5 and acquires a sensor response from the inertial sensor 5 as sensitivity information corresponding to the first temperature. Moreover, the sensor inspection device 30 performs temperature management such that the temperature of the inertial sensor 5 is the second temperature. Then, in a state where the temperature of the inertial sensor 5 is the second temperature, the sensor inspection device 30 outputs the sensor electric test signal to the inertial sensor 5 and acquires a sensor response from the inertial sensor 5 as sensitivity information corresponding to the second temperature. Then, in the step S14, the sensor inspection device 30 stores the sensitivity information corresponding to the first temperature and the sensitivity information corresponding to the second temperature as the pieces of sensor sensitivity information in the storage 4. The first temperature and the second temperature are respectively, for example, 25° C. and 85° C. Note that the temperature environments are not limited to the temperatures described above but may be arbitrary temperatures. Moreover, a third temperature, a fourth temperature, and the like may be used.

Moreover, in the second variation, the method for inspecting the module 10 is different from that in the embodiment in the following point. That is, the module inspection device 40 according to the second variation has a function of changing the temperature of the module 10 to the first temperature and maintaining the first temperature. Moreover, the module inspection device 40 according to the second variation has a function of changing the temperature of the module to a second temperature and maintaining the second temperature. To acquire the module sensitivity information in the step S21, the module inspection device 40 performs temperature management such that the temperature of the module 10 is the first temperature. Then, in a state where the temperature of the module 10 is the first temperature, the module inspection device 40 outputs the module electric test signal to the module 10 and acquires a sensor response from the module 10 as sensitivity information corresponding to the first temperature. Moreover, the module inspection device 40 performs temperature management such that the temperature of the module 10 is the second temperature. Then, in a state where the temperature of the module 10 is the second temperature, the module inspection device 40 outputs the module electric test signal to the module 10 and acquires a sensor response from the module 10 as sensitivity information corresponding to the second temperature. Then, in the step S23, the module inspection device 40 makes a comparison between the module sensitivity information thus calculated in the step S21 and the sensor sensitivity information thus read from the module 10 in the step S22 for each temperature environment. That is, the module inspection device 40 makes a comparison between the module sensitivity information corresponding to the first temperature environment and the sensor sensitivity information corresponding to the first temperature environment. The module inspection device 40 further makes a comparison between the module sensitivity information corresponding to the second temperature environment and the sensor sensitivity information corresponding to the second temperature environment. Then, in the step S24, the module inspection device 40 determines whether the module 10 is non-defective or defective with reference to all results of the comparisons for the temperature environments. That is, whether the module 10 is non-defective or defective is determined with reference to both the result of the comparison between the pieces of sensitivity information on the first temperature environment and the result of the comparison between the pieces of sensitivity information on the second temperature environment.

According to the present variation, the pieces of sensitivity information corresponding to an identical temperature environment are compared with each other, and therefore, even when the sensor sensitivity is temperature-dependent, the module 10 can be highly accurately inspected. Moreover, the pieces of sensitivity information for the plurality of temperature environments are compared with each other, and therefore, a defect that the sensitivity of the module 10 is abnormal only at some temperatures is detectable.

Moreover, in the case of an inspection using an inertial force, to inspect the module 10 in a temperature environment of a high temperature or a low temperature, a drive mechanism for giving the inertial force to the module 10 also has to be in the temperature environment. Therefore, the module inspection device also has to have high-temperature tolerance or low-temperature tolerance, which leads to an increase in inspection cost. In contrast, in the inspection method of the second variation, temperature management of the module 10 is at least performed when the module 10 is inspected by using the module electric test signal. Therefore, the inspection of the module 10 in a temperature environment of a high temperature or a low temperature may be carried out with low cost.

Note that the first variation and the second variation are combined with each other, and as the sensor sensitivity information or the module sensitivity information corresponding to the first temperature environment, a difference between the sensor response to the first test signal at the first temperature and the sensor response to the second test signal at the first temperature may be used. A similar description applies to the second temperature environment. In particular, when the component St, which is not attributed to the electric test signal, changes depending on a change in the environmental temperature, a highly accurate inspection can be conducted.

(Third Variation)

In the embodiment, the sensor sensitivity information on the inertial sensor 5 to the sensor electric test signal is compared with the module sensitivity information on the module 10 to the module electric test signal identical to the sensor electric test signal. However, as long as the accuracy of correspondence between the module electric test signal and the inertial force is satisfactorily secured, the sensor sensitivity information on the inertial sensor 5 to the inertial force may be compared with the module sensitivity information on the module 10 to the module electric test signal.

In a third variation, the sensor inspection device 30 stores, as the sensor sensitivity information, a sensor response from the inertial sensor 5 to the inertial force in the storage 4. The module inspection device 40 acquires, as the module sensitivity information, a sensor response from the module 10 to the module electric test signal. Then, the module inspection device 40 compares the module sensitivity information on the module electric test signal with the sensor sensitivity information on the inertial force, thereby inspecting the module 10. Note that the other steps are the same as those in the embodiment, and the description thereof will thus be omitted.

The method for inspecting the inertial sensor according to the third variation is different from that in the embodiment in the following point. That is, in the step S14, the sensor inspection device 30 stores, as the sensor sensitivity information, the sensor response corresponding to the inertial force and acquired in the step S11 in the storage 4.

In the method for inspecting the module 10 according to the third variation, operation is similar to that in the embodiment. However, in the method for inspecting the module 10 according to the third variation, the sensor sensitivity information which the module inspection device 40 reads from the storage 4 in the step S22 is not information corresponding to the module electric test signal but is information corresponding to the inertial force. Then, in the step S23, the module inspection device 40 makes a comparison between the module sensitivity information on the module electric test signal and the sensor sensitivity information on the inertial force.

In order to perform the method for inspecting the module 10 according to the third variation, the following condition is required. That is, when a sensor electric test signal identical to the module electric test signal in the step S21 is output from the sensor inspection device 30 to the inertial sensor 5, sensor sensitivity information identical to the sensor sensitivity information stored in the storage 4 has to be obtainable. In order to check whether or not this condition is satisfied in the method for inspecting the module 10 according to the third variation, the sensor inspection device 30 may output the sensor electric test signal to the inertial sensor 5 in the step S13 to acquire the sensor sensitivity information. Moreover, the sensor inspection device 30 may verify whether the sensor sensitivity information on the sensor electric test signal acquired in the step S13 is identical to the sensor sensitivity information on the inertial force acquired in the step S11. When the degree of identicalness between the two pieces of sensor sensitivity information is satisfactorily high, it can be verified that the module electric test signal identical to the sensor electric test signal corresponds to the inertial force. Moreover, when the degree of identicalness between sensor sensitivity information on the sensor electric test signal acquired in the step S13 and the sensor sensitivity information on the inertial force acquired in the step S11 is low, the sensor test signal may be adjusted as described below. That is, the voltage value representing a sensor test signal included in the sensor electric test signal may be increased or reduced, and then, acquisition of sensor sensitivity information on the sensor electric test signal and a comparison with the sensor sensitivity information corresponding to the inertial force may be made. The accuracy of the module electric test signal identical to the sensor electric test signal can be satisfactorily increased. Note that when satisfactorily high accuracy of the module electric test signal has been verified, the step S13 in the method for inspecting the inertial sensor 5 may be omitted.

(Other Variations)
(1) In the embodiment and each variation, the inertial sensor 5 stores the sensor sensitivity information on the inertial sensor 5 in the storage 4. However, information which the inertial sensor 5 stores in the storage 4 is not limited to this example. For example, the sensor inspection device 30 may further store information representing the sensor electric test signal in the storage 4, and when inspecting the module 10, the module inspection device 40 may read, and use, the information representing the sensor electric test signal from the storage 4. This method can secure the identicalness between the sensor electric test signal used by the sensor inspection device 30 and the module electric test signal used by the module inspection device 40. Moreover, this method facilitates making the sensor electric test signal different for each inertial sensor 5. In similar fashion, in the second variation, pieces of information representing temperatures of the inertial sensor 5 corresponding to respective pieces of sensor sensitivity information stored in the storage 4 may be further stored in the storage 4.
(2) In the embodiment and each variation, the sensor sensitivity information on the inertial sensor 5 is stored in the storage 4 of the inertial sensor 5. However, as long as the sensor sensitivity information on the inertial sensor 5 is acquired at the time of inspecting the module 10, a storage other than the storage 4 of the inertial sensor 5 may be used. For example, the sensor inspection device 30 may store a combination of information individually identifying the inertial sensor 5 and sensor sensitivity information on the inertial sensor 5 in a storage medium such as USB memory, and when inspecting the module 10, the module inspection device 40 may acquire the sensor sensitivity information from the storage medium. Moreover, for example, a database from which the module inspection device 40 can acquire the sensor sensitivity information on the inertial sensor 5 by using the information individually identifying the inertial sensor 5 as a key may be used over a network. The information individually identifying the inertial sensor 5 may be, for example, a serial number. Alternatively, for example, the information individually identifying the inertial sensor 5 may be stored in a barcode or the like which is to be affixed on a surface of the inertial sensor 5. Still alternatively, for example, information representing the location of the sensor sensitivity information on the inertial sensor 5 or the sensor sensitivity information itself may be stored in a two-dimensional barcode or the like which is to be affixed to a surface of the inertial sensor 5.
(3) In the embodiment and each variation, the sensor electric test signal includes one or more test signals. Moreover, there are three types of sensor test signals, namely a signal corresponding to the positive inertial force in the x-axis direction and producing the potential difference between the weight 21 and the test signal electrode 23a, a signal corresponding to the negative inertial force in the x-axis direction and producing the potential difference between the weight 21 and the test signal electrode 23b, and a signal not corresponding to the inertial force. However, the sensor electric test signal may be an arbitrary signal as long as it is obtainable by outputting, to the inertial sensor 5, a sensor response similar to the sensor response when the inertial force is caused to act on the inertial sensor 5. Moreover, the sensor electric test signal may be a signal representing that an inspection of acquiring a sensor response to the sensor electric test signal is conducted. When receiving the sensor electric test signal, the test signal generating circuit 1 applies, to the MEMS portion 2, a predetermined voltage stored in advance. A similar description applies to the module electric test signal.
(4) In the embodiment and each variation, the inertia detecting portion, which is the MEMS portion 2, is an electrostatic capacitance sensor but is not limited to this example. For example, the inertia detecting portion may be a piezoelectric sensor, or the inertia detecting portion does not have to be a so-called MEMS sensor. As long as the module 10 includes the inertial sensor 5, and the inertial sensor 5 is a sensor configured to obtain, by application of the sensor electric test signal, a sensor response identical to the sensor response obtainable by causing the action of the inertial force, they can be subjected to the inspection method according to an aspect of the present disclosure.

### SUMMARY

A module inspection method of a first aspect is a module inspection method of a module (10) in which an inertial sensor (5) is incorporated. The module inspection method includes acquiring sensor sensitivity information corresponding to a predetermined inertial force of the inertial sensor (5). The module inspection method of the first aspect further includes applying a module electric test signal to the inertial sensor (5) incorporated in the module (10) to obtain module sensitivity information corresponding to the predetermined inertial force. The module inspection method of the first aspect further includes making a comparison between the module sensitivity information and the sensor sensitivity information and inspecting the module (10) with reference to a result of the comparison between the module sensitivity information and the sensor sensitivity information.

The module inspection method of the first aspect enables the module (10) to be inspected without the predetermined inertial force caused to act on the module (10). Thus, a facility configured to give an inertial force to the module (10) larger than the inertial sensor (5) is no longer required, thereby reducing an increase in inspection cost. Moreover, an inspection is conducted based on the comparison between the sensor sensitivity information and the module sensitivity information, thereby reducing the influence of the accuracy of the module electric test signal over the accuracy of the inspection.

In a module inspection method of a second aspect referring to the first aspect, the sensor sensitivity information is sensitivity information obtained by causing the predetermined inertial force to act on the inertial sensor (5) or sensitivity information obtained by applying, to the inertial sensor (5), a sensor electric test signal set based on the predetermined inertial force.

According to the module inspection method of the second aspect, a sensitivity property of the inertial sensor (5) can be highly accurately obtained. Thus, a sensitivity property of the module (10) can be highly accurately inspected.

In a module inspection method of a third aspect referring to the second aspect, the sensor sensitivity information is the sensitivity information obtained by applying the sensor electric test signal to the inertial sensor. The module electric test signal is a signal identical to the sensor electric test signal.

According to the module inspection method of the third aspect, the sensitivity property of the inertial sensor (5) and the sensitivity property of the module (10) can be obtained under an identical condition. Thus, the sensitivity property of the inertial sensor (5) and the sensitivity property of the module (10) can be highly accurately compared with each other.

In a module inspection method of a fourth aspect referring to the third aspect, the sensor electric test signal includes a first test signal and a second test signal. The sensor sensitivity information is information on a difference between a sensor response to the first test signal and a sensor response to the second test signal. The module electric test signal includes a first module test signal identical to the first test signal and a second module test signal identical to the second test signal. The module sensitivity information is information on a difference between a sensor response to the first module test signal and a sensor response to the second module test signal.

According to the module inspection method of the fourth aspect, an influence which a condition other than the electric test signal exerts the sensor response of the inertial sensor (5) can be excluded from the sensitivity information. The condition other than the electric test signal is, for example, a position of the inertial sensor (5). Thus, even when, for example, the position of the inertial sensor (5) which is the condition other than the electric test signal does not have to be the same between generation of the sensor sensitivity information and generation of the module sensitivity information, a highly accurate inspection is possible.

In a module inspection method of a fifth aspect referring to the second aspect, the sensor sensitivity information is the sensitivity information obtained by causing the predetermined inertial force to act on the inertial sensor (5). The module electric test signal is an electric signal obtainable by applying, to the inertial sensor (5), sensitivity information identical to the sensitivity information obtainable by causing the predetermined inertial force to act on the inertial sensor (5).

According to the module inspection method of the fifth aspect, the module sensitivity information is obtainable as a response to the module test signal identical to the sensor test signal which is applied to the inertial sensor (5) to obtain the sensor sensitivity information. Thus, the sensor sensitivity information and the module sensitivity information can be highly accurately compared with each other.

In a module inspection method of a sixth aspect referring to the first aspect, the sensor sensitivity information includes a plurality of pieces of sensitivity information corresponding to respective temperature environments different from each other. In the module inspection method of the sixth aspect, a step of obtaining the module sensitivity information and a step of making a comparison between the module sensitivity information and the sensor sensitivity information are performed for each of the respective temperature environments.

According to the module inspection method of the sixth aspect, an inspection can be conducted in consideration of temperature dependency of the sensitivity information on the inertial sensor (5) to the test signal. Thus, a highly accurate inspection a highly accurate inspection is possible. Moreover, temperature dependency of the sensitivity information on the module (10) can be inspected by changing an environmental temperature of the module (10). That is, even when the environmental temperature widely ranges, no inspection devices corresponding to respective environmental temperatures and configured to give inertia to the module (10) are required. Thus, in the module inspection method of the sixth aspect, the inspection can be conducted without increasing inspection cost.

An inertial sensor (5) of a seventh aspect is an inertial sensor (5) for the module inspection method of any one of the first to sixth aspects and includes a storage (4) configured to store the sensor sensitivity information.

According to the inertial sensor of the seventh aspect, the sensor sensitivity information acquired by inspection of the inertial sensor can be read from the module (10). Thus, when the module (10) is inspected, the sensor sensitivity information can be easily and securely acquired.

### REFERENCE SIGNS LIST

10 Module
5 Inertial Sensor
4 Storage

1. A module inspection method of a module in which an inertial sensor is incorporated, the module inspection method comprising:
acquiring sensor sensitivity information corresponding to a predetermined inertial force of the inertial sensor;
applying a module electric test signal to the inertial sensor incorporated in the module to obtain module sensitivity information corresponding to the predetermined inertial force;
making a comparison between the module sensitivity information and the sensor sensitivity information; and
inspecting the module with reference to a result of the comparison between the module sensitivity information and the sensor sensitivity information.

2. The module inspection method of claim 1, wherein
the sensor sensitivity information is
sensitivity information obtained by causing the predetermined inertial force to act on the inertial sensor or
sensitivity information obtained by applying, to the inertial sensor, a sensor electric test signal set based on the predetermined inertial force.

3. The module inspection method of claim 2, wherein
the sensor sensitivity information is the sensitivity information obtained by applying the sensor electric test signal to the inertial sensor, and
the module electric test signal is a signal identical to the sensor electric test signal.

4. The module inspection method of claim 3, wherein
the sensor electric test signal includes
a first test signal and
a second test signal,
the sensor sensitivity information is information on a difference between a sensor response to the first test signal and a sensor response to the second test signal,
the module electric test signal includes
a first module test signal identical to the first test signal and
a second module test signal identical to the second test signal, and
the module sensitivity information is information on a difference between a sensor response to the first module test signal and a sensor response to the second module test signal.

5. The module inspection method of claim 2, wherein
the sensor sensitivity information is the sensitivity information obtained by causing the predetermined inertial force to act on the inertial sensor, and
the module electric test signal is an electric signal obtainable by applying, to the inertial sensor, sensitivity information identical to the sensitivity information obtainable by causing the predetermined inertial force to act on the inertial sensor.

6. The module inspection method of claim 1, wherein
the sensor sensitivity information includes a plurality of pieces of sensitivity information corresponding to respective temperature environments different from each other, and
a step of obtaining the module sensitivity information and a step of making a comparison between the module sensitivity information and the sensor sensitivity information are performed for each of the respective temperature environments.

7. An inertial sensor for the module inspection method of claim 1, the inertial sensor comprising a storage configured to store the sensor sensitivity information.
